(19) United States
(12) Patent Application Publication
(10) Pub. No.: US 2023/0061461 A1
(43) Pub. Date: Mar. 2, 2023

(54) LOCKING SYSTEM FOR A THREE-POINT HITCH QUICK COUPLER

(71) Applicant: CNH Industrial America LLC, New Holland, PA (US)

(72) Inventor: Thomas James Paulson, Fargo, ND (US)

(73) Assignee: CNH Industrial America LLC, (omitted)

(21) Appl. No.: 17/459,300

(22) Filed: Aug. 27, 2021

(51) Int. Cl. A01B 59/00; B60D 1/04; B60D 1/14; A01B 59/06

(52) U.S. Cl. CPC A01B 59/006; A01B 59/066; B60D 1/04; B60D 1/141

(57) ABSTRACT

A locking assembly for a three-point hitch quick coupler includes a locking plate configured to be movably coupled to a main support of the three-point hitch quick coupler. The locking plate is configured to block removal of a lower hitch pin from a lower hook of the three-point hitch quick coupler while the locking plate is in a closed position, and the locking plate is configured to enable removal of the lower hitch pin from the lower hook while the locking plate is in an open position. The locking assembly also includes an actuator coupled to the locking plate and configured to be coupled to the main support of the three-point hitch quick coupler. The actuator is configured to drive the locking plate to move between the open and closed positions.

### BACKGROUND

The present disclosure relates generally to a locking system for a three-point hitch quick coupler.

Certain work vehicles, such as tractors, include a three-point hitch configured to engage a corresponding hitch of a towed implement. Certain three-point hitches include two lower lift arms and an upper link. Each lower lift arm includes an opening configured to receive a corresponding lower hitch pin of the towed implement hitch, and the upper link includes an opening configured to receive a corresponding upper hitch pin of the towed implement hitch. Each hitch pin may be disposed within a corresponding opening to couple the towed implement to the work vehicle.

To reduce the duration associated with coupling the work vehicle to the towed implement, a quick coupler may be coupled to the three-point hitch. The quick coupler may include lower hitch pins and an upper hitch pin, and each hitch pin may be disposed within a corresponding opening in the three-point hitch to couple the quick coupler to the three-point hitch. In addition, the quick coupler includes two lower hooks and an upper/anti-rotation hook. The lower hooks are configured to engage the lower hitch pins of the towed implement hitch, and the upper/anti-rotation hook is configured to engage the upper hitch pin of the towed implement hitch. For example, once the quick coupler is coupled to the three-point hitch, each hook may be aligned with a corresponding hitch pin of the towed implement hitch. The quick coupler may then be raised by the three-point hitch such that each hook engages the corresponding hitch pin. In addition, one or more locking mechanisms may be engaged to secure one or more hitch pins within the respective hooks. Accordingly, the duration associated with coupling the work vehicle to the towed implement may be significantly reduced (e.g., as compared to engaging each hitch pin of the towed implement hitch with a corresponding opening of the three-point hitch), and the duration associated with switching between different towed implements may also be significantly reduced.

Certain quick couplers include a locking mechanism for each lower hook. Each locking mechanism may include a locking plate configured to selectively block and enable removal of the lower hitch pin from the respective lower hook. The locking plate may be coupled to a handle via a linkage, and the handle may be mounted on a side of the quick coupler. Accordingly, an operator may manually move each handle to lock and unlock the lower hitch pin from the respective lower hook. For example, while the operator is positioned within a cab of the work vehicle, the operator may move the work vehicle to align each hook with a corresponding hitch pin of the towed implement hitch. The operator may then raise the three-point hitch via controls in the cab, such that each hook engages the corresponding hitch pin. Finally, the operator may exit the cab, approach the quick coupler, and actuate the handles to lock the lower hitch pins within the respective lower hooks. In addition, to unlock the lower hitch pins after an agricultural operation is complete, the operator may exit the cab, approach the quick coupler, and actuate the handles to unlock the lower hitch pins from the respective lower hooks. The operator may then reenter the cab, lower the three-point hitch, and move the work vehicle away from the towed implement. As a result, the process of coupling and uncoupling the towed implement from the work vehicle may be time-consuming and inconvenient for the operator.

### BRIEF DESCRIPTION

In certain embodiments, a locking assembly for a three-point hitch quick coupler includes a locking plate configured to be movably coupled to a main support of the three-point hitch quick coupler. The locking plate is configured to block removal of a lower hitch pin from a lower hook of the three-point hitch quick coupler while the locking plate is in a closed position, and the locking plate is configured to enable removal of the lower hitch pin from the lower hook while the locking plate is in an open position. The locking assembly also includes an actuator coupled to the locking plate and configured to be coupled to the main support of the three-point hitch quick coupler. The actuator is configured to drive the locking plate to move between the open and closed positions. In addition, the locking assembly includes at least one actuating line coupled to the actuator and configured to extend to a work vehicle coupled to the three-point hitch quick coupler.

### DRAWINGS

These and other features, aspects, and advantages of the present disclosure will become better understood when the following detailed description is read with reference to the accompanying drawings in which like characters represent like parts throughout the drawings, wherein:

FIG. 1 is a side view of an embodiment of a work vehicle coupled to an implement via a three-point hitch;

FIG. 2 is a front perspective view of an embodiment of a quick coupler coupled to the three-point hitch of FIG. 1;

FIG. 3 is a block diagram of an embodiment of a locking system that may be employed within the quick coupler of FIG. 2;

FIG. 4 is a cross-sectional view of an embodiment of a locking assembly that may be employed within the locking system of FIG. 3, in which a locking plate of the locking assembly is in an open position;

FIG. 5 is a cross-sectional view of the locking assembly of FIG. 4, in which the locking plate is in a closed position; and

FIG. 6 is a cross-sectional view of another embodiment of a locking assembly that may be employed within the locking system of FIG. 3.

### DETAILED DESCRIPTION

One or more specific embodiments of the present disclosure will be described below. In an effort to provide a concise description of these embodiments, all features of an actual implementation may not be described in the specification. It should be appreciated that in the development of any such actual implementation, as in any engineering or design project, numerous implementation-specific decisions must be made to achieve the developers’ specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments of the present disclosure, the articles “a,” “an,” “the,” and “said” are intended to mean that there are one or more of the elements. The terms “comprising,” “including,” and “having” are intended to be inclusive and mean that there may be additional elements other than the listed elements. Any examples of operating parameters and/or environmental conditions are not exclusive of other parameters/conditions of the disclosed embodiments.

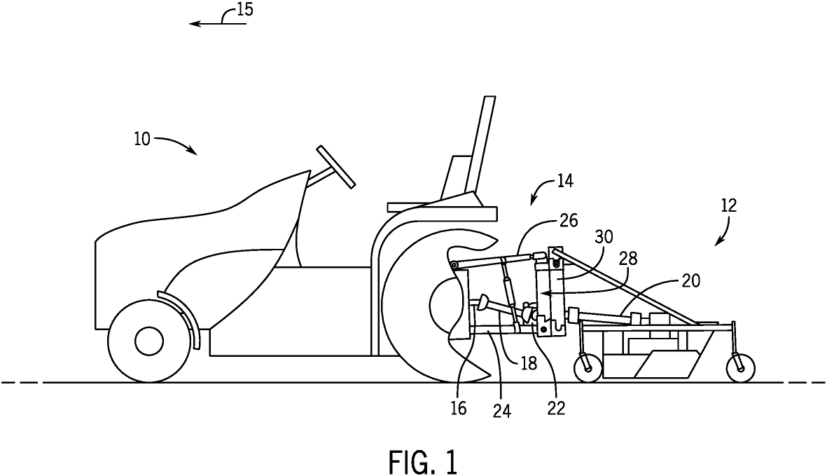

FIG. 1 is a side view of an embodiment of a work vehicle 10 coupled to an implement 12 via a three-point hitch 14. The work vehicle 10 is configured to tow the implement 12 (e.g., through a field) along a direction of travel 15. In the illustrated embodiment, the work vehicle 10 is a tractor. However, in other embodiments, the work vehicle may be any other suitable type of work vehicle configured to tow an implement, such as a harvester or a sprayer. Furthermore, in the illustrated embodiment, the implement 12 is a powered implement, such as a spreader, a rotary mower, or a rotary tiller. The implement is powered by a power-take off (PTO) shaft 16 of the work vehicle 10. An engine of the work vehicle 10 drives the PTO shaft to rotate (e.g., via a transmission, a PTO drive system, etc.), and rotation of the PTO shaft drives rotation of one or more rotary components of the implement 12, such as a rotary spreader system, mower blades, or a rotary tillage assembly. In the illustrated embodiment, the PTO shaft 16 includes a telescoping portion 18 configured to facilitate adjustment of a length of the PTO shaft 16 to accommodate different types of powered implements. However, in other embodiments, the work vehicle may have a non-telescoping PTO shaft.

As illustrated, the PTO shaft 16 of the work vehicle 10 is coupled to a corresponding shaft 20 of the implement 12, and the corresponding shaft 20 of the implement 12 is configured to drive rotation of the rotary component(s) of the implement 12. The PTO shaft 16 and the corresponding shaft 20 of the implement 12 are coupled to one another via a connection assembly 22. The connection assembly 22 may include any suitable device(s) configured to couple the PTO shaft 16 to the corresponding shaft 20, such that rotation of the PTO shaft 16 drives the corresponding shaft 20 to rotate. While the implement 12 is a powered implement in the illustrated embodiment, in other embodiments, the implement may be a non-powered implement, such as a vertical tillage implement, a primary tillage implement, a seeding implement, or a finishing implement. In such embodiments, the PTO shaft of the work vehicle may not be coupled to a corresponding shaft of the implement, or the work vehicle may not include a PTO shaft.

In the illustrated embodiment, the implement 12 is coupled to the work vehicle 10 via the three-point hitch 14 of the work vehicle 10. As discussed in detail below, the three-point hitch 14 includes two lower lift arms 24 and an upper link 26. The two lower lift arms 24 and the upper link 26 are coupled (e.g., rotatably coupled) to a chassis of the work vehicle 10. In certain embodiments, an actuator is coupled to the lower lift arms and configured to drive the lower lift arms to rotate relative to the chassis of the work vehicle. Each lower lift arm 24 includes an opening configured to receive a corresponding lower hitch pin of the implement 12, and the upper link 26 includes an opening configured to receive a corresponding upper hitch pin of the implement 12. In certain embodiments, each hitch pin of the implement 12 may be disposed within a corresponding opening to couple the implement 12 to the work vehicle 10. Unfortunately, the process of coupling the hitch pins to the lower lift arms and the upper link may be time consuming, thereby increasing the duration associated with agricultural operations.

In the illustrated embodiment, a quick coupler 28 is coupled to the three-point hitch 14 to reduce the duration associated with coupling the work vehicle 10 to the implement 12. As discussed in detail below, the quick coupler 28 includes openings configured to receive two lower hitch pins and an upper hitch pin. Each hitch pin is configured to be disposed within a corresponding opening in the three-point hitch. The hitch pins may be engaged with the openings in the quick coupler and the corresponding openings in the three-point hitch, thereby coupling the quick coupler to the three-point hitch. In addition, the quick coupler 28 includes two lower hooks and an upper/anti-rotation hook. The lower hooks are configured to engage the lower hitch pins of the implement 12 (e.g., which are coupled to a hitch frame 30 of the implement 12), and the upper/anti-rotation hook is configured to engage the upper hitch pin of the implement 12 (e.g., which is coupled to the hitch frame 30 of the implement 12). For example, once the quick coupler 28 is coupled to the three-point hitch 14, each hook may be aligned with a corresponding hitch pin of the implement 12. The quick coupler 28 may then be raised by the three-point hitch (e.g., via the actuator coupled to the lower lift arms 24), such that each hook engages the corresponding hitch pin of the implement 12. As a result, the implement 12 (e.g., the hitch frame 30 of the implement 12) is coupled to the quick coupler 28, thereby coupling the implement 12 to the three-point hitch 14 of the work vehicle 10. In addition, to uncouple the implement from the three-point hitch of the work vehicle, the quick coupler 28 may be lowered by the three-point hitch (e.g., via the actuator coupled to the lower lift arms 24), such that each hook disengages the corresponding hitch pin of the implement 12. Accordingly, the duration associated with coupling the work vehicle 10 to the implement 12 and uncoupling the work vehicle from the implement may be significantly reduced (e.g., as compared to engaging each hitch pin of the implement with a corresponding opening of the three-point hitch/disengaging each hitch pin of the implement from the corresponding opening of the three-point hitch), thereby significantly reducing the duration associated with switching between different implements.

In certain embodiments, the quick coupler 28 (e.g., three-point hitch quick coupler) includes a locking assembly having a locking plate movably coupled to a main support of the quick coupler 28. The locking plate is configured to block removal of a lower hitch pin from a respective lower hook of the quick coupler 28 while the locking plate is in a closed position, and the locking plate is configured to enable removal of the lower hitch pin from the respective lower hook while the locking plate is in an open position. The locking assembly also includes an actuator coupled to the locking plate and to the main support of the quick coupler 28. The actuator is configured to drive the locking plate to move between the open and closed positions. In addition, the locking assembly includes one or more actuating lines coupled to the actuator and extending to the work vehicle 10. In certain embodiments (e.g., in embodiments in which the actuator includes an electromechanical actuator), the actuating line(s) include electrical line(s) communicatively coupled to a controller of the work vehicle. Furthermore, in certain embodiments (e.g., in embodiments in which the actuator includes a hydraulic actuator and/or a pneumatic actuator), the actuating line(s) include pneumatic and/or hydraulic line(s) coupled to a valve assembly of the work vehicle. The actuating line(s) and the actuator enable control of the locking plate from the cab of the work vehicle, thereby enabling the operator to engage and disengage the locking assembly without exiting the cab. As a result, the operator may complete the entire process of coupling the quick coupler to the implement and the entire process of uncoupling the quick coupler from the implement without leaving the cab. Accordingly, the duration associated with coupling the work vehicle to the implement and uncoupling the work vehicle from the implement may be further reduced (e.g., as compared to a process in which the operator manually actuates a handle on the quick coupler to selectively engage and disengage the locking assembly), thereby further reducing the duration associated with switching between different implements.

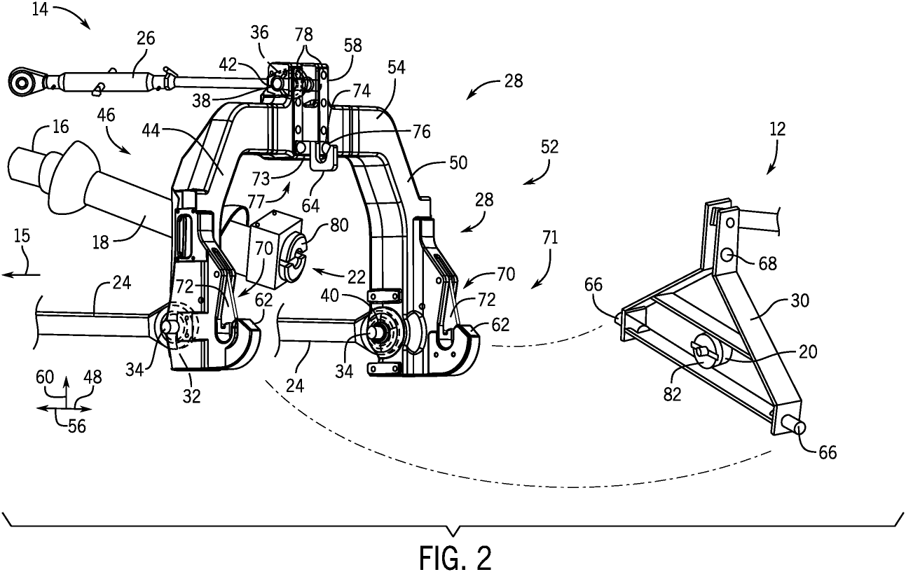

FIG. 2 is a front perspective view of an embodiment of a quick coupler 28 coupled to the three-point hitch 14 of FIG. 1. In the illustrated embodiment, each lower lift arm 24 has an opening 32 configured to receive a respective lower hitch pin 34, and the upper link 26 has an opening 36 configured to receive a respective upper hitch pin 38. In addition, the quick coupler 28 includes two lower openings 40 configured to receive the lower hitch pins 34 and an upper opening 42 configured to receive the upper hitch pin 38. The hitch pins are configured to be disposed through the openings in the three-point hitch and the quick coupler to couple the quick coupler 28 to the three-point hitch 14. In certain embodiments, each hitch pin may include an aperture on each longitudinal side of the hitch pin, and a cotter pin may be disposed through each aperture to secure the hitch pin to the three-point hitch and the quick coupler. However, in other embodiments, another suitable connection system may be used to couple the hitch pins to the three-point hitch and the quick coupler (e.g., at least one end of at least one hitch pin may include threads configured to receive a fastener, etc.).

In the illustrated embodiment, the quick coupler 28 includes a first main support 44 positioned on a first lateral side 46 of the quick coupler 28 (e.g., a first side along a lateral axis 48). In addition, the quick coupler 28 includes a second main support 50 positioned on a second lateral side 52 of the quick coupler 28 (e.g., a second side along the lateral axis 48), in which the second lateral side 52 is opposite the first lateral side 46. Furthermore, the quick coupler 28 includes a cross-beam 54 extending between the first main support 44 and the second main support 50 along the lateral axis 48. As illustrated, the lateral axis 48 is perpendicular to a longitudinal axis 56, which may extend along (e.g., substantially along) the direction of travel 15. In addition, each lower opening 40 is disposed within a respective main support, and the upper opening 42 is disposed within a support 58 extending from the cross-beam 54. As illustrated, the upper opening 42 is positioned above the lower openings 40 along a vertical axis 60.

In the illustrated embodiment, the quick coupler 28 includes two lower hooks 62 and an upper (e.g., anti-rotation) hook 64. As illustrated, a first lower hook 62 extends from the first main support 44, and a second lower hook 62 extends from the second main support 50. Each lower hook 62 is configured to engage a corresponding lower hitch pin 66 of the implement 12. As illustrated, the lower hitch pins 66 extend laterally outward from opposite lateral sides of the hitch frame 30 of the implement 12. Furthermore, the upper/anti-rotation hook 64 is configured to engage a corresponding upper hitch pin 68 of the implement 12. As illustrated, the upper hitch pin 68 is positioned at a top portion of the hitch frame 30 of the implement 12. As previously discussed, once the quick coupler 28 is coupled to the three-point hitch 14, each hook may be aligned with a corresponding hitch pin of the implement 12. The quick coupler 28 may then be raised by the three-point hitch (e.g., via the actuator coupled to the lower lift arms 24), such that each hook engages the corresponding hitch pin of the implement 12. As a result, the hitch frame 30 of the implement 12 is coupled to the quick coupler 28, thereby coupling the implement 12 to the three-point hitch 14 of the work vehicle 10.

In the illustrated embodiment, the quick coupler 28 includes two locking assemblies 70 of a locking system 71. Each locking assembly 70 includes a locking plate 72 configured to selectively block removal of a respective lower hitch pin 66 of the implement 12 while the lower hitch pin 66 is engaged with the respective lower hook 62. For example, after each lower hitch pin 66 is engaged with the respective lower hook 62, the respective locking assembly 70 may be engaged to block removal of the lower hitch pin from the lower hook. In addition, to remove each lower hitch pin from the respective lower hook, the respective locking assembly 70 may be disengaged. As discussed in detail below, each locking assembly 70 includes an actuator coupled to the locking plate and to the respective main support. The actuator is configured to drive the locking plate 72 to move between closed and open positions to selectively engage and disengage the locking assembly 70. In addition, one or more actuating line(s) may be coupled to the actuator of each locking assembly and extend to the work vehicle. The actuating line(s) and the actuator of each locking assembly enable control of the respective locking plate from the cab of the work vehicle, thereby enabling the operator to engage and disengage the locking assemblies without exiting the cab. As a result, the operator may complete the entire process of coupling the quick coupler to the implement and the entire process of uncoupling the quick coupler from the implement without leaving the cab. In addition, the actuator of each locking assembly may be positioned entirely within an internal cavity of the respective main support. As a result, the appearance of the quick coupler may be enhanced (e.g., as compared to a quick coupler that includes an external handle coupled to the respective main support and configured to manually move the locking plate).

Furthermore, in the illustrated embodiment, the upper/anti-rotation hook 64 is moveable between multiple positions along the vertical axis 60 (e.g., to accommodate different hitch frame configurations). In the illustrated embodiment, a mount 73 is coupled to (e.g., integrally formed with) the upper/anti-rotation hook 64, and the mount 73 includes apertures 74 configured to receive respective fasteners 76 (e.g., bolts, pins, etc.). While the mount 73 has two apertures in the illustrated embodiment, in other embodiments, the mount may include more or fewer apertures (e.g., 1, 3, 4, or more) configured to receive a corresponding number of fasteners. In addition, the cross-beam 54 and the support 58 of the quick coupler 28 include a mounting feature 77 having corresponding apertures 78 configured to receive the fasteners 76. Accordingly, the fasteners 76 may be disposed through the apertures 74 of the mount 73 and the apertures 78 of the cross-beam 54/support 58 to couple the upper/anti-rotation hook 64 to the cross-beam on the implement side of the quick coupler. In the illustrated embodiment, the cross-beam and the support include four sets of apertures 78 arranged long the vertical axis 60. Accordingly, the mount 73 may couple to the cross-beam/support at any one of four positions along the vertical axis 60, thereby positioning the upper/anti-rotation hook at a suitable vertical position for the implement. While the cross-beam/support have four sets of apertures in the illustrated embodiment, in other embodiments, the cross-beam/support may have more or fewer sets of apertures. In addition, in certain embodiments, the quick coupler (e.g., the cross-beam of the quick coupler) may have another suitable mounting feature configured to couple the upper/anti-rotation hook to the cross-beam and, in certain embodiments, to facilitate adjustment of the vertical position of the upper/anti-rotation hook (e.g., the mounting feature may include a slider mechanism, etc.). Furthermore, in certain embodiments, the upper/anti-rotation hook may be non-movably coupled to the cross-beam.

As previously discussed, the PTO shaft 16 is coupled to the corresponding shaft 20 of the implement 12 via the connection assembly 22. The connection assembly 22 includes a first connector 80 coupled to the PTO shaft 16 and a second connector 82 coupled to the corresponding shaft 20 of the implement 12. In the illustrated embodiment, the first connector 80 includes a recess configured to receive a protrusion of the second connector 82, thereby non-rotatably coupling the shafts to one another. However, in other embodiments, the first connector may include a protrusion and the second connector may include a recess configured to receive the protrusion to non-rotatably couple the shafts to one another. Furthermore, in other embodiments, the connection assembly may include any other suitable device(s)/element(s) configured to selectively couple the PTO shaft to the corresponding implement shaft. As previously discussed, coupling the PTO shaft to the corresponding implement shaft enables the PTO shaft to drive rotation of one or more rotary components of the implement.

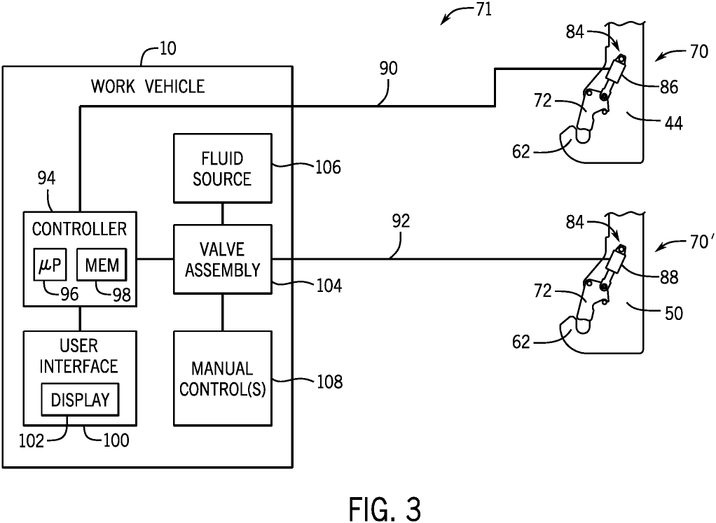

FIG. 3 is a block diagram of an embodiment of a locking system 71 that may be employed within the quick coupler of FIG. 2. In the illustrated embodiment, the locking system 71 includes a first locking assembly 70 and a second locking assembly 70’. As previously discussed, each locking assembly includes a locking plate 72 movably coupled to a main support of the quick coupler. For example, the locking plate 72 of the first locking assembly 70 may be movably coupled to the first main support 44, and the locking plate 72 of the second locking assembly 70’ may be movably coupled to the second main support 50. Each locking plate 72 is configured to block removal of a lower hitch pin from a respective lower hook 62 of the quick coupler while the locking plate 72 is in the closed position. In addition, each locking plate 72 is configured to enable removal of the lower hitch pin from the respective lower hook 62 while the locking plate is in the open position. Furthermore, each locking assembly includes an actuator 84 coupled to the locking plate 72 and to the respective main support of the quick coupler. Each actuator 84 is configured to drive the respective locking plate 72 between the open and closed positions. In the illustrated embodiment, each locking plate 72 is pivotally coupled to the respective main support, and the respective actuator 84 is configured to drive the locking plate to rotate between the open and closed positions. However, in other embodiments, at least one locking plate may be translatably coupled to the respective main support, and the respective actuator may be configured to drive the locking plate to translate between the open and closed positions. Furthermore, in certain embodiments, at least one locking plate may be rotatably and translatably coupled to the respective main support, and the respective actuator may be configured to drive the locking plate to rotate and translate between the open and closed positions.

In the illustrated embodiment, the actuator 84 of the first locking assembly 70 includes an electromechanical actuator 86 (e.g., electric screw drive, electric linear actuator, electric motor, etc.), and the actuator 84 of the second locking assembly 70’ includes a pneumatic or hydraulic actuator 88 (e.g., pneumatic cylinder, hydraulic cylinder, airbag, pneumatic motor, hydraulic motor, etc.). As illustrated, the first locking assembly 70 includes one or more electrical lines 90 (e.g., actuating line(s)) coupled to the electromechanical actuator 86 and extending to the work vehicle 10. In addition, the second locking assembly 70’ includes one or more pneumatic or hydraulic lines 92 (e.g., actuating line(s)) coupled to the pneumatic/hydraulic actuator 88 and extending to the work vehicle 10. For example, in embodiments in which the pneumatic/hydraulic actuator 88 is a pneumatic actuator, the locking assembly may include pneumatic line(s) 92, and in embodiments in which the pneumatic/hydraulic actuator 88 is a hydraulic actuator, the locking assembly may include hydraulic line(s) 92. The actuating lines and the actuators enable control of the locking plates from the cab of the work vehicle, thereby enabling the operator to engage and disengage the locking assemblies without exiting the cab. As a result, the operator may complete the entire process of coupling the quick coupler to the implement and the entire process of uncoupling the quick coupler from the implement without leaving the cab. Accordingly, the duration associated with coupling the work vehicle to the implement and uncoupling the work vehicle from the implement may be reduced (e.g., as compared to a process in which the operator manually actuates handles on the quick coupler to selectively engage and disengage the locking assemblies), thereby reducing the duration associated with switching between different implements.

In the illustrated embodiment, the locking system 71 includes a controller 94 communicatively coupled to the actuator 84 of the first locking assembly 70. As illustrated, the controller 94 is coupled to the work vehicle 10. For example, the controller 94 may be disposed within a cab of the work vehicle 10, coupled to an exterior surface of the work vehicle 10, positioned within an engine compartment of the work vehicle 10, or positioned at another suitable location of the work vehicle 10. The controller 94 is configured to instruct the actuators 84 to drive the respective locking plates 72 to move between the open and closed positions. In certain embodiments, the controller 94 is an electronic controller having electrical circuitry configured to control the actuators 84. In the illustrated embodiment, the controller 94 includes a processor, such as the illustrated microprocessor 96, and a memory device 98. The controller 94 may also include one or more storage devices and/or other suitable components. The processor 96 may be used to execute software, such as software for controlling the actuators 84, and so forth. Moreover, the processor 96 may include multiple microprocessors, one or more “general-purpose” microprocessors, one or more special-purpose microprocessors, and/or one or more application specific integrated circuits (ASICs), or some combination thereof. For example, the processor 96 may include one or more reduced instruction set (RISC) processors.

The memory device 98 may include a volatile memory, such as random access memory (RAM), and/or a nonvolatile memory, such as read-only memory (ROM). The memory device 98 may store a variety of information and may be used for various purposes. For example, the memory device 98 may store processor-executable instructions (e.g., firmware or software) for the processor 98 to execute, such as instructions for controlling the actuators 84, and so forth. The storage device(s) (e.g., nonvolatile storage) may include ROM, flash memory, a hard drive, or any other suitable optical, magnetic, or solid-state storage medium, or a combination thereof. The storage device(s) may store data, instructions (e.g., software or firmware for controlling the actuators 84, etc.), and any other suitable data.

In the illustrated embodiment, the locking system 71 includes a user interface 100 communicatively coupled to the controller 94. The user interface 100 is configured to receive input from an operator and, in certain embodiments, to provide information to the operator. The user interface 100 may include any suitable input device(s) for receiving input, such as a keyboard, a mouse, button(s), switch(es), knob(s), other suitable input device(s), or a combination thereof. In addition, the user interface 100 may include any suitable output device(s) for presenting information to the operator, such as a speaker, indicator light(s), other suitable output device(s), or a combination thereof. In the illustrated embodiment, the user interface 100 includes a display 102 configured to present visual information to the operator. In certain embodiments, the display 102 may include a touchscreen interface configured to receive input from the operator.

As previously discussed, the first locking assembly 70 includes an electromechanical actuator 86, and one or more electrical lines extend from the electromechanical actuator 86 to the work vehicle 10. In the illustrated embodiment, the electrical line(s) 90 extend from the electromechanical actuator 86 to the controller 94. Accordingly, the controller 94 may instruct the electromechanical actuator 86 to move the locking plate 72 between the open and closed positions (e.g., via signal(s) output to the electromechanical actuator via the electrical line(s)). For example, the operator may provide an input to the user interface 100 indicative of engaging the first locking assembly 70, and the user interface 100, in turn, may output a signal (e.g., user input signal) to the controller 94 indicative of engaging the first locking assembly 70 (e.g., indicative of moving the locking plate to the closed position). In response to receiving the signal, the controller 94 may instruct the electromechanical actuator 86 to drive the locking plate 72 to the closed position. In addition, the operator may provide an input to the user interface 100 indicative of disengaging the first locking assembly 70, and the user interface 100, in turn, may output a signal (e.g., user input signal) to the controller 94 indicative of disengaging the first locking assembly 70 (e.g., indicative of moving the locking plate to the open position). In response to receiving the signal, the controller 94 may instruct the electromechanical actuator 86 to drive the locking plate 72 to the open position. Furthermore, in certain embodiments, the controller 94 may instruct the electromechanical actuator 86 to move the locking plate 72 between the open and closed positions based on other data/input(s) (e.g., alone or in combination with input from the user interface), such as input from another device (e.g., a remote device), input from sensor(s), data indicative of a geographic location of the work vehicle, other suitable data/input(s), or a combination thereof. Furthermore, while the controller 94 is configured to control the electromechanical actuator via the electrical line(s) 90 in the illustrated embodiment, in other embodiments, the controller may be configured to control the electromechanical actuator via other suitable connection(s) (e.g., alone or in combination with the electrical line(s)), such as a wireless connection, a fiber optic connection, other suitable connection(s), or a combination thereof.

As previously discussed, the second locking assembly 70′ includes a pneumatic or hydraulic actuator 88, and one or more pneumatic or hydraulic lines 92 extend from the pneumatic/hydraulic actuator 88 to the work vehicle 10. In the illustrated embodiment, the locking system 71 includes a valve assembly 104 fluidly coupled to the pneumatic/hydraulic line(s) 92. In embodiments in which the pneumatic/hydraulic actuator 88 is a pneumatic actuator, the locking assembly 70′ may include pneumatic line(s) 92, and the valve assembly 104 may include pneumatic valve(s). In addition, in embodiments in which the pneumatic/hydraulic actuator 88 is a hydraulic actuator, the locking assembly 70’ may include hydraulic line(s) 92, and the valve assembly 104 may include hydraulic valve(s). The valve assembly 104 is configured to control fluid flow to/from the pneumatic/hydraulic actuator 88 to control the position of the respective locking plate. For example, in certain embodiments, to move the locking plate 72 to the closed position, the valve assembly 104 may enable fluid (e.g., air, hydraulic fluid, etc.) to flow from a fluid source 106 (e.g., including a reservoir and a pump) to a cap end of the pneumatic/hydraulic actuator 88 and to enable fluid to flow from a rod end of the pneumatic/hydraulic actuator to a fluid drain. In addition, to move the locking plate 72 to the open position, the valve assembly 104 may enable fluid (e.g., air, hydraulic fluid, etc.) to flow from the fluid source 106 to the rod end of the pneumatic/hydraulic actuator 88 and to enable fluid to flow from the cap end of the pneumatic/hydraulic actuator to the fluid drain. However, in other embodiments, to move the locking plate 72 to the closed position, the valve assembly 104 may enable fluid to flow from the fluid source 106 to the rod end of the pneumatic/hydraulic actuator 88 and to enable fluid to flow from the cap end of the pneumatic/hydraulic actuator to the fluid drain. In addition, to move the locking plate 72 to the open position, the valve assembly 104 may enable fluid to flow from the fluid source 106 to the cap end of the pneumatic/hydraulic actuator 88 and to enable fluid to flow from the rod end of the pneumatic/hydraulic actuator to the fluid drain. While a double-acting pneumatic/hydraulic actuator is disclosed above, in certain embodiments, the locking assembly may include a single-acting pneumatic/hydraulic actuator, in which fluid is provided to/received from a single end of the actuator. For example, the single-acting pneumatic/hydraulic actuator may be configured to selectively drive the locking plate in one direction, and a biasing device (e.g., spring, pneumatic shock, etc.) may be configured to urge the locking plate in the opposite direction.

In the illustrated embodiment, the valve assembly 104 is communicatively coupled to the controller 94, and the valve assembly 104 is configured to control fluid flow to/from the pneumatic/hydraulic actuator 88 in response to instructions from the controller 94. For example, the operator may provide an input to the user interface 100 indicative of engaging the second locking assembly 70′, and the user interface 100, in turn, may output a signal (e.g., user input signal) to the controller 94 indicative of engaging the second locking assembly 70′ (e.g., indicative of moving the locking plate to the closed position). In response to receiving the signal, the controller 94 may instruct the valve assembly 104 to control fluid flow to/from the pneumatic/hydraulic actuator 88 to drive the locking plate 72 to the closed position. In addition, the operator may provide an input to the user interface 100 indicative of disengaging the second locking assembly 70′, and the user interface 100, in turn, may output a signal (e.g., user input signal) to the controller 94 indicative of disengaging the second locking assembly 70′ (e.g., indicative of moving the locking plate to the open position). In response to receiving the signal, the controller 94 may instruct the valve assembly 104 to control fluid flow to/from the pneumatic/hydraulic actuator 88 to drive the locking plate 72 to the open position. Furthermore, in certain embodiments, the controller 94 may instruct the valve assembly 104 to control fluid flow to/from the pneumatic/hydraulic actuator 88 to drive the locking plate 72 to move between the open and closed positions based on other data/input(s) (e.g., alone or in combination with input from the user interface), such as input from another device (e.g., a remote device), input from sensor(s), data indicative of a geographic location of the work vehicle, other suitable data/input(s), or a combination thereof. Furthermore, in certain embodiments, the locking system 71 may include manual control(s) 108 coupled to the valve assembly 104 and configured to control the valve assembly 104 (e.g., alone or in combination with the controller).

While each locking assembly has a single actuator 84 in the illustrated embodiment, in other embodiments, at least one locking assembly may include multiple actuators (e.g., 2, 3, 4, or more). The multiple actuators may be of the same type (e.g., hydraulic, pneumatic, electromechanical) or of different types. Furthermore, while the first locking assembly 70 includes an electromechanical actuator 86 and the second locking assembly 70′ includes a pneumatic/hydraulic actuator 88 in the illustrated embodiment, in other embodiments, the first and second locking assemblies may have the same type of actuators. For example, the locking system may only include electromechanical actuator(s), the locking system may only include pneumatic actuator(s), or the locking system may only include hydraulic actuator(s). In addition, in certain embodiments, the first locking assembly (e.g., the locking assembly positioned at the first main support) may include a pneumatic or hydraulic actuator, and the second locking assembly (e.g., the locking assembly positioned at the second main support) may include an electromechanical actuator. Furthermore, in certain embodiments, one locking assembly may include a pneumatic actuator, and another locking assembly may include a hydraulic actuator. In such embodiments, the locking system may include a pneumatic valve assembly, a hydraulic valve assembly, pneumatic line(s), and hydraulic line(s). In embodiments including multiple pneumatic actuators or multiple hydraulic actuators, the pneumatic/hydraulic actuators may be fluidly coupled in a parallel flow arrangement, a serial flow arrangement, or another suitable flow arrangement (e.g., a combination of serial and parallel, etc.). While the locking system includes two locking assemblies in the illustrated embodiment, in other embodiments, the locking system may include more or fewer locking assemblies (e.g. 1, 3, 4, or more), such as one locking assembly for each main support of the quick coupler.

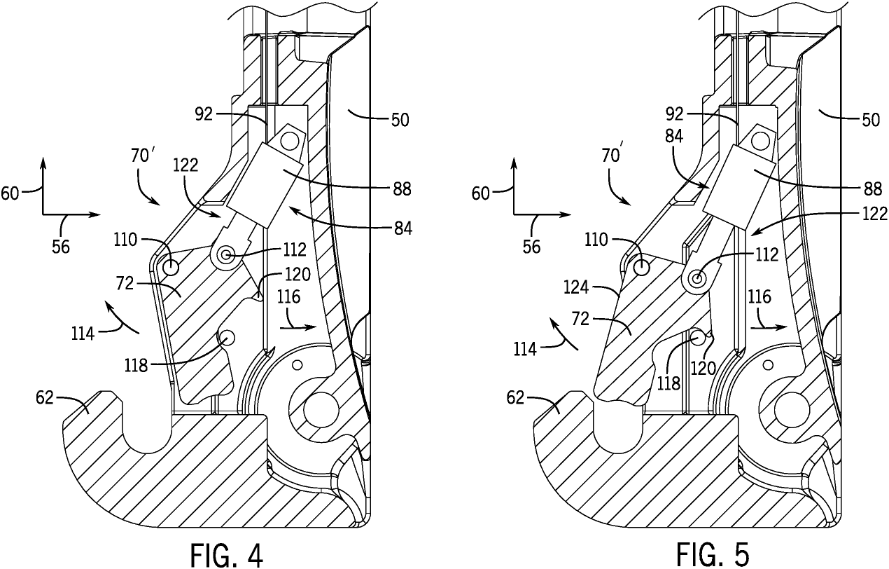

FIG. 4 is a cross-sectional view of an embodiment of a locking assembly 70′ (e.g., the second locking assembly 70′) that may be employed within the locking system of FIG. 3, in which the locking plate 72 of the locking assembly is in an open position. As previously discussed, with the locking plate 72 in the open position, the respective lower hook 62 may receive a respective lower hitch pin. In the illustrated embodiment, the locking assembly 70′ includes the pneumatic/hydraulic actuator 88 and the pneumatic/hydraulic line(s) 92. However, in other embodiments, the locking assembly may include the electromechanical actuator and the electrical line(s). Furthermore, the structure and arrangement of components, as well as the functions of the components, described with reference to FIGS. 4-5 may apply to any of the locking assembly configurations/embodiments described above.

In the illustrated embodiment, the locking plate 72 is pivotally coupled to the respective main support (e.g., the second main support 50), and the actuator 84 is configured to drive the locking plate 72 to rotate between the illustrated open position and the closed position. As illustrated, the locking plate 72 is pivotally coupled to the main support by a first pivot pin 110, and the first pivot pin 110 is configured to enable the locking plate 72 to rotate about the lateral axis between the open and closed positions. However, in other embodiments, the locking plate may be pivotally coupled to the main support by any other suitable rotatable connection (e.g., bearing, bushing, etc.), and/or the locking plate may be configured to rotate about any other suitable axis between the open and closed positions.

In the illustrated embodiment, the actuator 84 is pivotally coupled to the locking plate 72 by a second pivot joint 112. However, in other embodiments, the actuator may be pivotally coupled to the locking plate by any other suitable rotatable connection (e.g., bearing, bushing, etc.), or the actuator may be non-pivotally coupled to the locking plate by any suitable type(s) of connection(s). Furthermore, in certain embodiments, the actuator may be coupled to the locking plate by a linkage assembly. The actuator 84 is configured to drive the locking plate 72 to rotate between the open and closed positions. In the illustrated embodiment, the actuator 84 is configured to extend to drive the locking plate 72 to rotate in a first direction 114 from the illustrated open position to the closed position, and the actuator 84 is configured to retract to drive the locking plate 72 to rotate in a second direction 116, opposite the first direction 114, from the closed position to the open position. However, in other embodiments, the actuator may be configured (e.g., positioned, oriented, connected, etc.) to retract to drive the locking plate to rotate in the first direction from the open position to the closed position, and the actuator may be configured to extend to drive the locking plate to rotate in the second direction from the closed position to the open position.

In the illustrated embodiment, the locking assembly 70’ includes a stop 118 (e.g., pin, protrusion, rod, etc.) coupled to the respective main support (e.g., the second main support 50), and the locking plate 72 includes a protrusion 120 configured to contact the stop 118. The protrusion 120 is configured to contact the stop 118 to block rotation of the locking plate 72 in the first direction 114 (e.g., the direction between the open position and the closed position) while the locking plate 72 is in the closed position, thereby blocking over-rotation of the locking plate 72 in the first direction. While the locking assembly includes a stop and the locking plate includes a protrusion in the illustrated embodiment, in other embodiments, the stop/protrusion may be omitted. Additionally or alternatively, the locking assembly may be configured to block over-rotation of the locking plate in the first direction by other suitable structure(s) and/or technique(s) (e.g., alone or in combination with the protrusion/stop configuration). For example, the controller may be configured to stop rotation of the locking plate when the locking plate reaches the closed position (e.g., based on feedback from sensor(s)). Furthermore, in certain embodiments, the locking plate may be configured to contact a portion of the respective lower hook to block rotation of the locking plate in the first direction while the locking plate is in the closed position. In addition, in certain embodiments, an actuator stop (e.g., internal or external to the actuator) may block extension of the actuator in response to the locking plate reaching the closed position. Furthermore, in certain embodiments, the locking assembly may include one or more of the structure(s)/technique(s) disclosed above to block rotation of the locking plate in the second direction while the locking plate is in the open position, thereby blocking over-rotation of the locking plate in the second direction.

While the locking assembly includes a linear actuator in the illustrated embodiment, in other embodiments, the locking assembly may include one or more rotary actuators configured to drive the locking plate to rotate between the open and closed positions. For example, the locking assembly may include electric motor(s), pneumatic motor(s), hydraulic motor(s), other suitable type(s) of rotary actuator(s), or a combination thereof. Furthermore, while the locking plate 72 is configured to rotate between the open and closed positions in the illustrated embodiment, in other embodiments, the locking plate may be configured to translate between the open and closed positions, or the locking plate may be configured to rotate and translate between the open and closed positions. In such embodiments, a suitable actuator may be coupled to the locking plate (e.g., via a suitable linkage, etc.) to drive the locking plate to translate and/or rotate between the open and closed positions.

In the illustrated embodiment, the actuator 84 is positioned entirely within an internal cavity 122 of the respective main support (e.g., the second main support 50). In addition, the actuating line(s) (e.g., the pneumatic/hydraulic line(s) 92) extend through the internal cavity 122 of the respective main support (e.g., the second main support 50). As a result, the appearance of the quick coupler may be enhanced (e.g., as compared to a quick coupler that includes an external handle coupled to the respective main support and configured to manually move the locking plate). Because the actuator is internal to the respective main support, the internal cavity may be substantially sealed, thereby blocking dirt and/or water from entering the internal cavity. As a result, the longevity of the quick coupler may be increased (e.g., as compared to a quick coupler that includes an external handle extending through an opening in the quick coupler to the internal cavity). Furthermore, in certain embodiments, connectors may be disposed along the pneumatic/hydraulic line(s) to facilitate attachment of the quick coupler to the work vehicle and separation of the quick coupler from the work vehicle. For example, the connectors may include port(s) positioned at an outer surface of the quick coupler. A portion of each pneumatic/hydraulic line may extend through the internal cavity from the port to the actuator, and a portion of each pneumatic/hydraulic line may extend from a connector engaged with the port to the work vehicle (e.g., the valve assembly of the work vehicle).

While the actuating line(s) include the pneumatic/hydraulic line(s) 92 in the illustrated embodiment, in embodiments in which the locking assembly includes an electromechanical actuator and electrical line(s), the electrical line(s) may extend through the internal cavity. In addition, the electrical line(s) may also extend along the outer surface of the quick coupler, and the electrical line(s) may be coupled to the quick coupler by one or more retaining features (e.g., clip(s), fastener(s), etc.). Furthermore, in certain embodiments, connectors may be disposed along the electrical line(s) to facilitate attachment of the quick coupler to the work vehicle and separation of the quick coupler from the work vehicle. For example, the connectors may include first connector(s) positioned at an outer surface of the quick coupler. A portion of each electrical line may extend through the internal cavity from the first connector to the actuator, and a portion of each electrical line may extend from a second connector engaged with the first connector to the work vehicle (e.g., the controller of the work vehicle).

FIG. 5 is a cross-sectional view of the locking assembly 70′ of FIG. 4, in which the locking plate 72 is in a closed position. As previously discussed, with the locking plate 72 in the closed position, the locking plate blocks removal of a respective lower hitch pin from the respective lower hook 62. In addition, with the locking plate 72 in the illustrated closed position, the protrusion 120 contacts the stop 118, thereby blocking rotation of the locking plate 72 in the first direction 114.

In the illustrated embodiment, the locking plate 72 has an angled top surface 124. In addition, the actuator 84 is configured to enable the locking plate 72 to rotate from the illustrated closed position to the open position in response to engagement of the respective lower hitch pin with the angled top surface 124 of the locking plate 72 to enable engagement of the respective lower hitch pin with the respective lower hook 62. For example, to couple the quick coupler to the towed implement hitch, each hook of the quick coupler may be aligned with a corresponding hitch pin of the towed implement hitch. The quick coupler may then be raised by the three-point hitch of the work vehicle. As the quick coupler is raised, each lower hitch pin may contact the angled top surface 124 of the locking plate 72 of a respective locking assembly. As the quick coupler continues to move upwardly, each lower hitch pin may drive the locking plate 72 of the respective locking assembly to move in the second direction 116 via engagement with the angled top surface 124, thereby enabling the lower hitch pin to engage the respective lower hook 62. Once the lower hitch pin is engaged with the respective lower hook, the actuator 84 may automatically drive the locking plate 72 in the first direction 114 to the closed position, thereby blocking removal of the lower hitch pin from the respective lower hook 62. While the locking plate includes the angled top surface and the actuator is configured to enable the locking plate to rotate in the second direction in the illustrated embodiment, in other embodiments, the angled top surface may be omitted, and/or the actuator may be configured to block rotation of the locking plate in the second direction.

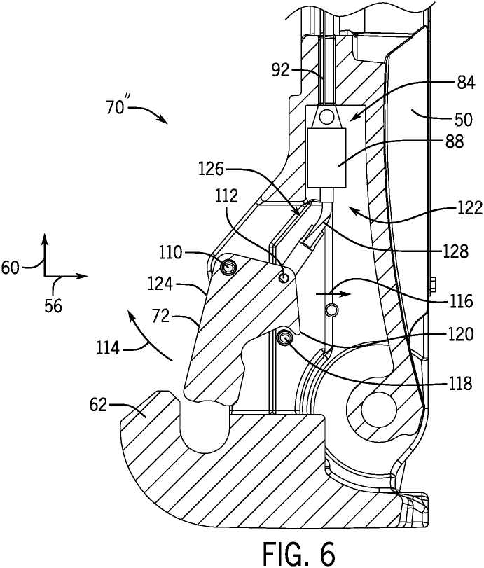

FIG. 6 is a cross-sectional view of another embodiment of a locking assembly 70′ that may be employed within the locking system of FIG. 3. In the illustrated embodiment, the locking assembly 70′ includes the pneumatic/hydraulic actuator 88 and the pneumatic/hydraulic line(s) 92. However, in other embodiments, the locking assembly may include the electromechanical actuator and the electrical line(s). In the illustrated embodiment, the actuator 84 is coupled to the locking plate 72 by a linkage assembly 126. The linkage assembly 126 includes a single link 128 non-pivotally coupled to the actuator 84 (e.g., a rod of the actuator) and pivotally coupled to the locking plate 72 by the second pivot joint 112. While the linkage assembly 126 includes a single link 128 in the illustrated embodiment, in other embodiments, the linkage assembly may include additional links (e.g., 1, 2, 3, 4, 5, 6, or more). In embodiments including multiple links, each pair of adjacent links may be movably and pivotally, non-movably and pivotally, movably and non-pivotally, or non-movably and non-pivotally coupled to one another. In addition, at least one link may be pivotally and/or movably coupled to the respective main support.

In the illustrated embodiment, the actuator 84 is configured to extend to drive the locking plate 72 to rotate in the first direction 114 from the open position to the closed position, and the actuator 84 is configured to retract to drive the locking plate 72 to rotate in the second direction 116 from the closed position to the open position. However, in other embodiments, the actuator may be configured (e.g., positioned, oriented, connected, etc.) to retract to drive the locking plate to rotate in the first direction from the open position to the closed position, and the actuator may be configured to extend to drive the locking plate to rotate in the second direction from the closed position to the open position. The linkage assembly described with reference to FIG. 6 may be employed within any of the locking assembly configurations/embodiments disclosed herein.

While only certain features have been illustrated and described herein, many modifications and changes will occur to those skilled in the art. It is, therefore, to be understood that the appended claims are intended to cover all such modifications and changes as fall within the true spirit of the disclosure.

The techniques presented and claimed herein are referenced and applied to material objects and concrete examples of a practical nature that demonstrably improve the present technical field and, as such, are not abstract, intangible or purely theoretical. Further, if any claims appended to the end of this specification contain one or more elements designated as “means for [perform]ing [a function]... ” or “step for [perform]ing [a function]... ”, it is intended that such elements are to be interpreted under 35 U.S.C. 112(f). However, for any claims containing elements designated in any other manner, it is intended that such elements are not to be interpreted under 35 U.S.C. 112(f).

1. A locking assembly for a three-point hitch quick coupler, comprising:
a locking plate configured to be movably coupled to a main support of the three-point hitch quick coupler, wherein the locking plate is configured to block removal of a lower hitch pin from a lower hook of the three-point hitch quick coupler while the locking plate is in a closed position, and the locking plate is configured to enable removal of the lower hitch pin from the lower hook while the locking plate is in an open position;
an actuator coupled to the locking plate and configured to be coupled to the main support of the three-point hitch quick coupler, wherein the actuator is configured to drive the locking plate to move between the open and closed positions; and
at least one actuating line coupled to the actuator and configured to extend to a work vehicle coupled to the three-point hitch quick coupler.

2. The locking assembly of claim 1, wherein the locking plate is configured to be pivotally coupled to the main support, and the actuator is configured to drive the locking plate to rotate between the open and closed positions.

3. The locking assembly of claim 2, wherein the locking plate comprises a protrusion configured to contact a stop to block rotation of the locking plate in a direction between the open position and the closed position while the locking plate is in the closed position.

4. The locking assembly of claim 2, wherein the locking plate has an angled top surface, and the actuator is configured to enable the locking plate to rotate from the closed position to the open position in response to engagement of the lower hitch pin with the angled top surface of the locking plate to enable engagement of the lower hitch pin with the lower hook.

5. The locking assembly of claim 1, wherein the actuator comprises a hydraulic actuator, and the at least one actuating line comprises at least one hydraulic line.

6. The locking assembly of claim 1, wherein the actuator comprises a pneumatic actuator, and the at least one actuating line comprises at least one pneumatic line.

7. The locking assembly of claim 1, wherein the actuator comprises an electromechanical actuator, and the at least one actuating line comprises at least one electrical line.

8. A three-point hitch quick coupler, comprising:
a first main support positioned on a first lateral side of the three-point hitch quick coupler;
a second main support positioned on a second lateral side of the three-point hitch quick coupler, opposite the first lateral side;
a cross-beam extending between the first main support and the second main support along a lateral axis; and
a locking system comprising a locking assembly, wherein the locking assembly comprises:
a locking plate movably coupled to the first main support, wherein the locking plate is configured to block removal of a lower hitch pin from a lower hook of the three-point hitch quick coupler while the locking plate is in a closed position, and the locking plate is configured to enable removal of the lower hitch pin from the lower hook while the locking plate is in an open position;
an actuator coupled to the locking plate and to the first main support, wherein the actuator is configured to drive the locking plate to move between the open and closed positions; and
at least one actuating line coupled to the actuator and configured to extend to a work vehicle coupled to the three-point hitch quick coupler.

9. The three-point hitch quick coupler of claim 8, wherein the actuator is positioned entirely within an internal cavity of the first main support.

10. The three-point hitch quick coupler of claim 8, wherein the at least one actuating line extends through an internal cavity of the first main support.

11. The three-point hitch quick coupler of claim 8, wherein the locking system comprises a second locking assembly, and the second locking assembly comprises:
a second locking plate movably coupled to the second main support, wherein the second locking plate is configured to block removal of a second lower hitch pin from a second lower hook of the three-point hitch quick coupler while the second locking plate is in a closed position, and the second locking plate is configured to enable removal of the second lower hitch pin from the second lower hook while the second locking plate is in an open position;
a second actuator coupled to the second locking plate and to the second main support, wherein the second actuator is configured to drive the second locking plate to move between the open and closed positions; and
at least one second actuating line coupled to the second actuator and configured to extend to the work vehicle.

12. The three-point hitch quick coupler of claim 8, wherein the locking plate is pivotally coupled to the first main support, and the actuator is configured to drive the locking plate to rotate between the open and closed positions.

13. The three-point hitch quick coupler of claim 12, wherein the locking assembly comprises a stop coupled to the first main support, and the locking plate comprises a protrusion configured to contact the stop to block rotation of the locking plate in a direction between the open position and the closed position while the locking plate is in the closed position.

14. The three-point hitch quick coupler of claim 12, wherein the locking plate has an angled top surface, and the actuator is configured to enable the locking plate to rotate from the closed position to the open position in response to engagement of the lower hitch pin with the angled top surface of the locking plate to enable engagement of the lower hitch pin with the lower hook.

15. The three-point hitch quick coupler of claim 8, wherein the actuator comprises a hydraulic actuator, a pneumatic actuator, or an electromechanical actuator.

16. A locking system for a three-point hitch quick coupler, comprising:
a locking assembly, comprising:
a locking plate configured to be movably coupled to a main support of the three-point hitch quick coupler, wherein the locking plate is configured to block removal of a lower hitch pin from a lower hook of the three-point hitch quick coupler while the locking plate is in a closed position, and the locking plate is configured to enable removal of the lower hitch pin from the lower hook while the locking plate is in an open position; and
an actuator coupled to the locking plate and configured to be coupled to the main support of the three-point hitch quick coupler, wherein the actuator is configured to drive the locking plate to move between the open and closed positions; and
a controller comprising a memory and a processor, wherein the controller is communicatively coupled to the actuator, and the controller is configured to instruct the actuator to drive the locking plate to move between the open and closed positions.

17. The locking system of claim 16, comprising a user interface communicatively coupled to the controller, wherein the user interface is configured to output a user input signal to the controller indicative of a selected position of the locking plate, and the controller is configured to instruct the actuator to drive the locking plate to move to the selected position of the open and closed positions based on the user input signal.

18. The locking system of claim 16, wherein the locking plate is configured to be pivotally coupled to the main support, and the actuator is configured to drive the locking plate to rotate between the open and closed positions.

19. The locking system of claim 16, wherein the actuator comprises a hydraulic actuator, a pneumatic actuator, or an electromechanical actuator.

20. The locking system of claim 16, comprising a valve assembly, wherein the controller is communicatively coupled to the actuator via the valve assembly, and the valve assembly is configured to control fluid flow to the actuator in response to instructions from the controller.
